(19) United States
(12) Patent Application Publication
(10) Pub. No.: US 2018/0002548 A1
(43) Pub. Date: Jan. 4, 2018

(54) FLAME RETARDANT TREATING AGENT FOR KAPOK-FIBER OR KAPOK-NONWOVEN FABRIC

(71) Applicant: Hyundai Motor Company, Seoul (KR)

(72) Inventors: Oh Deok KWON, Suwon-si (KR); Won Jin SEO, Suwon-si (KR); Da Som YANG, Siheung-si (KR); Won Suk CHAE, lncheon (KR)

(73) Assignee: Hyundai Motor Company, Seoul (KR)

(21) Appl. No.: 15/345,363

(22) Filed: Nov. 7, 2016

(30) Foreign Application Priority Data
Jul. 4, 2016 (KR) 10-2016-0084064

(51) Int. Cl. C09D 7/12; D06M 13/292; C09D 171/02; D06M 101/06; C08K 5/521; C08K 5/5399

(52) U.S. Cl. CPC C09D 7/1233; D06M 13/292; C09D 171/02; C08K 5/521; C08K 5/5399; D06M 2101/06; D06M 2200/30

(57) ABSTRACT

Provided herein is a flame retardant agent that is useful for treating kapok-fiber or kapok-nonwoven fabric. Kapok-fiber or kapok-nonwoven fabric when treated with the flame retardant agent is capable of reducing the impact of fire and providing flame retardancy. The flame retardant treated kapok-fiber or kapok-nonwoven fabric has desired properties including acid resistance, light resistance, absence of stickiness, and absence of a glaucous appearance. Thus, the flame retardant treating agent is suitable for use with materials used in vehicles, clothes, bedclothes, and the like.

### CROSS-REFERENCE TO RELATED APPLICATION

This application claims under 35 U.S.C. §119(a) the benefit of Korean Patent Application No. 10-2016-0084064, filed on Jul. 4, 2016, the entire contents of which are herein incorporated herein by reference for all purposes.

### BACKGROUND

### Technical Field

The present disclosure relates to a flame retardant agent useful for treating a fiber or fabric, e.g, a kapok-fiber or kapok-nonwoven fabric.

### Background Art

Kapok is a tree belonging to the family Malvaceae which is native to tropical America, and widely found in Southeast Asia and Africa. Kapok-fiber is a seed-fiber obtained from the fruit of a kapok-tree. The kapok-fiber is a hollow natural fiber having a length of 8 mm to 32 mm, a width of 30 μm to 35 μm, and a circular or elliptical cross-section. The kapok-fiber includes a lot of air and thus is light and thermal, and glossy like silk. Further, the kapok-fiber is covered with natural wax and thus water-repellent. Besides, the kapok-fiber has the characteristics such as sound absorption, oil absorption, anti-bacterial function, deodorization, and far infra ray radiation and thus can be applied for various purposes.

However, the kapok-fiber has a short fiber length and a narrow cell wall and thus can be easily cut during a treatment such as carding. Further, since the kapok-fiber is ultralight, it can be scattered when manufactured into web or felt and result in a loss of raw material and increase the risk of fire. Thus, use of the kapok-fiber has been limited to furniture, fillers for bedclothes, and fillers for life jacket.

In recent years, there have been various attempts to utilize the kapok-fiber as an industrial material for thermal insulation, sound absorption, and oil absorption, by manufacturing the kapok-fiber into nonwoven fabric and the like. For example, a sound-absorbing material can been manufactured by filling a porous material with the kapok-fiber without a separate treatment, or an oil absorbing composite nonwoven fabric can be manufactured by blending the kapok-fiber with polypropylene synthetic fiber. Also, a sound-absorbing material formed from kapok-nonwoven fabric and thermoplastic or thermosetting resin has been developed. However, use of kapok-fiber remains limited because of its scattering properties.

The above information disclosed in this Background section is only for enhancement of understanding of the background of the invention and therefore it may include information that does not form the prior art that is already known in this country to a person of ordinary skill in the art.

### SUMMARY OF THE DISCLOSURE

The present invention has been made in an effort to provide a flame retardant treating agent with provides improved properties to fibers and/or fabrics such as kapok-fiber and kapok-nonwoven fabric.

An exemplary object of the present invention is to provide a flame retardant treating agent capable of suppressing scattering of kapok-fiber during fiber processing such as nonwoven fabric spinning. As the amount of the kapok-fiber increases during processing, the flame retardant agent reduces the possibility of fire caused by the scattering of the kapok-fiber. As such, the flame retardant agent provides flame retardancy that is required for industrial fibers.

Another exemplary object of the present invention is to provide kapok-fiber treated with the flame retardant treating agent.

Still another exemplary object of the present invention is to provide kapok-nonwoven fabric manufactured from kapok-fiber treated with the flame retardant treating agent using a needle punching process. Such a manufacturing process can be performed without the risk of fire caused by scattering of the kapok-fiber.

In one aspect, the present invention provides a flame retardant treating agent for treating kapok-fiber or kapok-nonwoven fabric. In an exemplary embodiment of the flame retardant treating agent, the flame retardant is dispersed in an aqueous solvent, a nonionic surfactant, and an anionic surfactant, and includes a water insoluble phosphate-based flame retardant in the form of oil and a water insoluble phosphate-based flame retardant in the form of powder at a weight ratio of from about 2:8 to about 8:2.

In another aspect, the present invention provides kapok-fiber treated with the above-described flame retardant treating agent.

In still another aspect, the present invention provides kapok-nonwoven fabric treated with the above-described flame retardant treating agent.

Scattering of the kapok-fiber and the risk of fire are suppressed in kapok-fibers treated with the flame retardant treating agent of the present invention during carding and needle punching processes for manufacturing nonwoven webs and felt.

The kapok-fiber treated with the flame retardant treating agent of the present invention has excellent flame retardancy and can be used to manufacture kapok-nonwoven fabric at a burning velocity of about 102 mm/min.

The kapok-fiber or kapok-nonwoven fabric treated with the flame retardant treating agent of the present invention has excellent acid resistance and light resistance and improved stickiness without generating a glaucous appearance.

Therefore, the kapok-fiber or kapok-nonwoven fabric treated with the flame retardant treating agent of the present invention is a suitable material for various industrial products such as vehicles, clothes, bedclothes, and the like.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention relates to a flame retardant treating agent to be applied to kapok-fiber or kapok-nonwoven fabric. Scattering of the kapok-fiber and the risk of fire caused by the scattering are suppressed with the kapok-fiber treated with the flame retardant treating agent of the present invention during spinning, carding and needle punching processes. Further, the kapok-fiber treated with the flame retardant treating agent of the present invention exhibits desired properties such as improved acid resistance and light resistance, reduced glaucous appearance and improved stickiness.

Details of the flame retardant treating agent according to the present invention are discussed infra.

An exemplary embodiment of the flame retardant treating agent of the present invention can be applied to kapok-fiber or kapok-nonwoven fabric, and prepared by dispersing a flame retardant in an aqueous dispersion formed of an aqueous solvent and a surfactant. The flame retardant is uniformly dispersed in the aqueous dispersion that includes an aqueous solvent, a nonionic surfactant, and an anionic surfactant. In some embodiments of the flame retardant treating agent, the flame retardant is dispersed at a concentration of from about 20 wt % to about 40 wt % (e.g., about 20, 21, 22, 23, 24, 25, 26, 27, 28, 29, 30, 31, 32, 33, 34, 35, 36, 37, 38, 39, or about 40 wt %) on the basis of the total weight of the aqueous dispersion. Such an aqueous dispersion includes the aqueous solvent of about 100 parts by weight, the nonionic surfactant of from about 1 part to about 10 parts (e.g., about 1 part, 2, 3, 4, 5, 6, 7, 8, 9, or about 10 parts) by weight, and the anionic surfactant of from about 1 part to about 10 parts (e.g., about 1 part, 2, 3, 4, 5, 6, 7, 8, 9, or about 10 parts) by weight.

In exemplary embodiments of the present invention, a water insoluble phosphate-based flame retardant which is not easily dissolved in water is selected and used as the flame retardant. Further, a water insoluble phosphate-based flame retardant in the form of oil and a water insoluble phosphate-based flame retardant in the form of powder are used and mixed at a weight ratio of about 2:8 to about 8:2 (e.g., about 2:8 to about 8:2, about 4:6 to about 6:4, or about 5:5). As the amount of the water insoluble phosphate-based flame retardant in the form of powder is increased in the flame retardant treating agent, flame retardancy may be improved. However, if the water insoluble phosphate-based flame retardant in the form of powder is included in an amount exceeding the above-described weight ratio, the acid resistance and the light resistance may deteriorate, and, thus, hydrolysis, yellowing, and glaucous appearance may occur. Yet, even if the amount of the water insoluble phosphate-based flame retardant in the form of oil is increased in the flame retardant treating agent, flame retardancy may only slightly improve. Further, as the amount of the water insoluble phosphate-based flame retardant in the form of oil is increased, the stickiness is increased, such that a needle cannot pass through fiber during a needle punching operation and causes deterioration in workability and damage to devices. Therefore, in the present invention, considering maximization of flame retardancy, acid resistance, light resistance, glaucous appearance, and stickiness, the water insoluble phosphate-based flame retardant in the form of oil and the water insoluble phosphate-based flame retardant in the form of powder may be used as a flame retardant as mixed at a weight ratio of from about 2:8 to about 8:2, preferably from about 4:6 to about 6:4, and more preferably about 5:5.

More details of each component constituting the flame retardant treating agent according to the present invention will be described.

Aqueous Solvent

In exemplary embodiments of the present invention, water, alcohol, or a mixture thereof may be used as an aqueous solvent. Preferably, water may be used as an aqueous solvent.

Surfactant

In exemplary embodiments of the present invention, a nonionic surfactant and an anionic surfactant are used to uniformly disperse a flame retardant and adjust the particle diameter of particles of the flame retardant.

Specifically, the nonionic surfactant functions to control particle size of a water insoluble phosphate-based flame retardant in the form of powder to a small size. Further, the anionic surfactant functions to uniformly disperse a dispersant in an aqueous dispersion.

The nonionic surfactant may include one or more selected from the group consisting of polyoxyalkylene nonionic surfactants, polyhydric alcohol nonionic surfactants, polyoxyethylene styrene phenyl ether nonionic surfactants, distyrylphenyl ethoxylate ethylene oxide adducts, and tridecyl ethoxylate ethylene oxide adducts.

The anionic surfactant may include one or more selected from the group consisting of alkyl ester sulfonate, alkyl sulfonate, alkyl phosphate, alkyl arylsulfonate, polyoxyalkylene alkyl ether sulfate, polyoxyalkylene alkyl ester phosphate, polyoxyalkylene alkyl ether carboxylate, poly carboxylate, turkey red oil, petroleum sulfonate, alkyldiphenyl-ether sulfonate, and tristyrenephenyl ethoxylate ethylene oxide sulfonate ammonium salt.

In exemplary embodiments of the flame retardant treating agent according to the present invention, an aqueous dispersion is prepared by including a nonionic surfactant of from about 1 part to about 10 parts(e.g., about 1 part, 2, 3, 4, 5, 6, 7, 8, 9, or about 10 parts) by weight and an anionic surfactant of from about 1 part to about 10 parts (e.g., about 1 part, 2, 3, 4, 5, 6, 7, 8, 9, or about 10 parts) by weight on the basis of 100 parts by weight of the aqueous solvent.

If the nonionic surfactant included in the aqueous dispersion is used less than about 1 part by weight, it becomes difficult to adjust the particle size of the water insoluble phosphate-based flame retardant in the form of powder to about 1 μm. While, if the nonionic surfactant is included in an amount more than about 10 parts by weight, a high-temperature stability of a product may decrease, which may cause difficulty in spraying and padding.

If the anionic surfactant included in the aqueous dispersion is used less than about 1 part by weight, it becomes difficult to uniformly disperse the flame retardant. While, if the anionic surfactant is included in an amount more than about 10 parts by weight, discoloration (yellowing) of kapok-fiber may occur.

Dispersant

In exemplary embodiments of the present invention, a water insoluble phosphate-based flame retardant is used as a dispersant.

Prior art methods use a water soluble flame retardant such as guanidine phosphate, phosphate carbamate, or the like but such a water soluble flame retardant can be hydrolyzed or dissolved in water, resulting in deterioration of flame retardancy, acid resistance and light resistance. Furthermore, since kapok-fiber is hydrophobic, it cannot absorb the water soluble flame retardant and thus scattering cannot be suppressed.

In exemplary embodiments of the present invention, a water insoluble phosphate-based flame retardant is selected and used as a flame retardant. Thus, it is possible to suppress scattering of kapok-fiber and also improve acid resistance and light resistance through a flame retardant treatment. Further, if a water insoluble phosphate-based flame retardant in the form of oil and a water insoluble phosphate-based flame retardant in the form of powder are used at an appropriate content ratio, the effect of providing flame retardancy is expected to be equivalent to flame retardancy.

In exemplary embodiments of the present invention, the water insoluble phosphate-based flame retardant in oil form may include one or more selected from the group consisting of bisphenol A bis(diphenylphosphate), resorcinol bis (diphenylphosphate), cresyldiphenyl phosphate, tritresyl phosphate, 2-biphenylyl diphenyl phosphate, and the like. More preferably, cresyldiphenyl phosphate, tritresyl phosphate, or a mixture thereof may be used as the water insoluble phosphate-based flame retardant in the form of oil. In some cases, these water insoluble phosphate-based flame retardant are cost-effective.

In exemplary embodiments of the present invention, amido phosphate may be used as the water insoluble phosphate-based flame retardant in powder form.

In the flame retardant treating agent according to the present invention, the flame retardant is dispersed at a concentration of from about 20 wt % to about 40 wt % (e.g., about 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, or about 40 wt %) on the basis of the weight of the aqueous dispersion. If the amount of the flame retardant dispersed in the flame retardant treating agent is less than about 20 wt %, the effect of providing flame retardancy to kapok-fiber or kapok-nonwoven fabric may be poor. While, if the flame retardant is included at a high concentration more than about 40 wt %, it is not easy to adjust the particle diameter of the flame retardant and it is difficult to induce uniform dispersion.

In exemplary embodiments of the flame retardant treating agent of the present invention, the flame retardant is uniformly dispersed in the aqueous dispersion containing water and a surfactant, and the water insoluble phosphate-based flame retardant in the form of powder of which the average particle size is adjusted to equal to or less than about (e.g., about 1 μm, 0.9 μm, 0.8 μm, 0.7 μm, 0.6 μm, 0.5 μm, 0.4 μm, 0.3 μm, 0.2 μm, 0.1 μm, or less) is dispersed.

Meanwhile, the present invention provides kapok-fiber or kapok-nonwoven fabric treated with the above-described flame retardant treating agent.

The flame retardant treatment may be carried out by depositing the kapok-fiber or kapok-nonwoven fabric in the flame retardant treating agent or spraying the flame retardant treating agent onto the kapok-fiber or kapok-nonwoven fabric. In some embodiments, the impregnated amount of the flame retardant may be preferably from about 30 wt % to about 40 wt % (e.g., about 30 wt %, 31 wt %, 32 wt %, 33 wt %, 34 wt %, 35 wt %, 36 wt %, 37 wt %, 38 wt %, 39 wt %, or 40 wt %) with respect to the weight of the kapok-fiber or kapok-nonwoven fabric.

Specifically, the flame retardant-treated kapok-fiber may be prepared by depositing the flame retardant treating agent onto the fiber while kapok-fiber is spun and woven, or spraying the flame retardant treating agent onto the fiber.

The flame retardant-treated kapok-nonwoven fabric may be prepared by depositing in the flame retardant treating agent or spraying the flame retardant treating agent during a spinning process or a needle punching process for manufacturing typical nonwoven fabric. That is, in a process of manufacturing kapok-nonwoven fabric including: a) spinning and weaving kapok-fiber; and b) manufacturing nonwoven fabric through a needle punching process to the woven kapok-fiber, the flame retardant treatment may be carried out by depositing in the flame retardant treating agent or spraying the flame retardant treating agent during the spinning process or the needle punching process.

The present invention is not particularly limited in the method of the flame retardant treatment of the flame retardant-treated kapok-fiber or kapok-nonwoven fabric.

The present invention will be described in more detail with reference to examples. The following examples illustrate the invention and are not intended to limit the same.

### EXAMPLES

The following examples illustrate the invention and are not intended to limit the same.

### Example 1

### Preparation of Flame Retardant Treating Agent

100 g of water, 10 g of a polyoxyalkylene nonionic surfactant, and 10 g of alkyl ester sulfonate anionic surfactant were uniformly dispersed to prepare an aqueous dispersion. A flame retardant including cresyldiphenyl phosphate in the form of oil and amido phosphate in the form of powder at a weight ratio of 2:8 was added as a water insoluble phosphate-based flame retardant into the prepared aqueous dispersion in a concentration of 30 wt %. Then, the flame retardant was uniformly dispersed in the aqueous dispersion to prepare a flame retardant treating agent.

### Example 2

### Preparation of Flame Retardant Treating Agent

A flame retardant treating agent was prepared in the same manner as Example 1 except that a flame retardant including cresyldiphenyl phosphate and amido phosphate at a weight ratio of 5:5 was added in a concentration of 30 wt %.

### Example 3

### Preparation of Flame Retardant Treating Agent

A flame retardant treating agent was prepared in the same manner as Example 1 except that a flame retardant including cresyldiphenyl phosphate and amido phosphate at a weight ratio of 8:2 was added in a concentration of 30 wt %.

### Comparative Example 1

### Preparation of Flame Retardant Treating Agent

A flame retardant treating agent was prepared in the same manner as Example 1 except that guanidine phosphate alone was added as a water soluble phosphate-based flame retardant in a concentration of 30 wt. %.

### Comparative Example 2

### Preparation of Flame Retardant treating agent

A flame retardant treating agent was prepared in the same manner as Example 1 except that cresyldiphenyl phosphate alone was added as a water insoluble phosphate-based flame retardant in the form of oil in a concentration of 30 wt %.

### Comparative Example 3

### Preparation of Flame Retardant Treating Agent

A flame retardant treating agent was prepared in the same manner as Example 1 except that diphenyl anilino phosphonate alone was added as a water insoluble phosphate-based flame retardant in the form of powder in a concentration of 30 wt %.

### PREPARATION EXAMPLES

Flame retardant-treated kapok-fiber and kapok-nonwoven fabric were prepared by the following method.

### Preparation Example 1

### Preparation of Flame Retardant-Treated Kapok-Fiber

The flame retardant was impregnated in kapok-fiber by depositing the kapok-fiber in each of the flame retardant treating agents prepared in Examples 1 to 3 and Comparative Examples 1 to 3. In this case, the impregnated amount of the flame retardant was set to 30 wt % with respect to the weight of the kapok-fiber.

The kapok-fiber in which the flame retardant was impregnated was dried at 120° C. for 10 minutes to obtain flame retardant-treated kapok-fiber.

### Preparation Example 2

### Preparation of Flame Retardant-Treated Kapok-Nonwoven Fabric

While spinning and weaving kapok-fiber, the flame retardant treating agents prepared in Examples 1 to 3 and Comparative Examples 1 to 3 were sprayed. In this case, the sprayed amount of the flame retardant was set to 30 wt % with respect to the weight of the kapok-fiber. The kapok-fiber in which the flame retardant was impregnated was dried at 120° C. for 10 minutes. Then, the flame retardant-treated kapok-fiber was manufactured into nonwoven fabric through a typical needle punching process.

### TEST EXAMPLES

The flame retardant-treated kapok-fiber and flame retardant-treated kapok-nonwoven fabric prepared in Preparation Example 1 or Preparation Example 2 were tested by the following method in order to measure the properties thereof.

Measurement of Increase in Amount (Amount of Flame Retardant Added to Fiber)

After the flame retardant-treated kapok-fiber prepared in Preparation Example 1 was completely dried, an increase in amount was measured according to the following Equation 1.

Increase in amount (%)=(Weight (g) of kapok-fiber after treatment of the following Equation 1.red in Preparation Example 1 or Preparation Example 2 were test×100 [Equation 1]

Scattering

When the increase in amount measured according to Equation 1 was 30%, it was determined that there was no scattering.

Hydrolysis Resistance

The flame retardant-treated kapok-fiber prepared in Preparation Example 1 was kept at a humidity of 100% and a temperature of 120° C. for 48 hours using an autoclave. Then, a pH of the kapok-fiber kept in the autoclave was measured.

Occurrence of Yellowing

The flame retardant-treated kapok-fiber prepared in Preparation Example 1 was kept at a humidity of 100% and a temperature of 120° C. for 5 hours using an autoclave. Then, a change in color of the kapok-fiber kept in the autoclave was checked (KS M ISO 2440:2002) to determine whether or not yellowing occurs.

Generation of Glaucous Appearance

The flame retardant-treated kapok-fiber prepared in Preparation Example 1 was completely dried, and then, whether or not white dust was present on a surface of the fiber was checked.

Stickiness

The flame retardant-treated kapok-fiber prepared in Preparation Example 1 was completely dried, and then, the texture of the fiber was checked with hands.

Flame Retardancy

A flame retardancy test was conducted on the flame retardant-treated kapok-nonwoven fabric prepared in Preparation Example 2 according to FMVSS 302 (Federal Motor Vehicle Safety Standard).

The results of the above-described method are shown in the following Table 1.

According to the results as listed in Table 1, the kapok-fiber treated with the flame retardant treating agent suggested in the present invention was not scattered due to the increase in amount of about 42% to 47% and had excellent acid resistance and light resistance without glaucous appearance and stickiness. Further, the kapok-nonwoven fabric treated with the flame retardant treating agent suggested in the present invention had excellent flame retardancy. Although it was expected that flame retardancy would be improved as the amount of a water insoluble phosphate-based flame retardant in the form of powder is increased, it was confirmed that Example 2 including the water insoluble phosphate-based flame retardants in the form of oil and in the form of powder in the same amount had the highest flame retardancy according to the above-described test results.

Meanwhile, the flame retardant treating agent including the water soluble phosphate-based flame retardant prepared in Comparative Example 1 was excellent in flame retardancy, but caused scattering and did not improve acid resistance and light resistance. Therefore, it can be seen that the flame retardant treating agent of Comparative Example 1 is not suitable for treating kapok-fiber or kapok-nonwoven fabric.

Comparative Example 2 and Comparative Example 3 were flame retardant treating agents including only the water insoluble phosphate-based flame retardant in the form of oil and only the water insoluble phosphate-based flame retardant in the form of powder, respectively.

The kapok-fiber treated with the flame retardant treating agent of Comparative Example 2 was not scattered due to a great increase in amount of 58% and had an excellent acid resistance without glaucous appearance, but deteriorated in light resistance and was excessively sticky. Further, the kapok-nonwoven fabric treated with the flame retardant treating agent of Comparative Example 2 was very poor in flame retardancy and thus limited in use as a flame retardant material.

The kapok-fiber treated with the flame retardant treating agent of Comparative Example 3 had excellent flame retardancy and acid resistance without scattering, but glaucous appearance occurred.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A flame retardant treating agent for kapok-fiber or kapok-nonwoven comprising a water insoluble phosphate-based flame retardant in a form of oil and a water insoluble phosphate-based flame retardant in a form of powder at a weight ratio of about 2:8 to about 8:2, wherein said flame retardant is dispersed in an aqueous dispersion comprising an aqueous solvent, a nonionic surfactant, and a anionic surfactant.

2. The flame retardant treating agent of claim 1, wherein the flame retardant is dispersed at a concentration of from about 20 wt % to about 40 wt % based on a total weight of the aqueous dispersion comprising the aqueous solvent of from about 100 parts by weight, the nonionic surfactant of from about 1 part to about 10 parts by weight, and the anionic surfactant of from about 1 part to about 10 parts by weight.

3. The flame retardant treating agent of claim 1, wherein the water insoluble phosphate-based flame retardant in the form of powder having an adjusted particle size of equal to or less than about 1 μm is dispersed.

4. The flame retardant treating agent of claim 1, wherein the aqueous solvent is water.

5. The flame retardant treating agent of claim 1, wherein the water insoluble phosphate-based flame retardant in the form of oil is cresyldiphenyl phosphate, tritresyl phosphate, or a mixture thereof.

6. The flame retardant treating agent of claim 1, wherein the water insoluble phosphate-based flame retardant in the form of powder is amido phosphate.

7. The flame retardant treating agent of claim 1, wherein the nonionic surfactant comprises one or more selected from the group consisting of polyoxyalkylene nonionic surfactants, polyhydric alcohol nonionic surfactants, polyoxyethylene styrene phenyl ether nonionic surfactants, distyrylphenyl ethoxylate ethylene oxide adducts, and tridecyl ethoxylate ethylene oxide adducts.

8. The flame retardant treating agent of claim 1, wherein the anionic surfactant comprises one or more selected from the group consisting of alkyl ester sulfonate, alkyl sulfonate, alkyl phosphate, alkyl arylsulfonate, polyoxyalkylene alkyl ether sulfate, polyoxyalkylene alkyl ester phosphate, polyoxyalkylene alkyl ether carboxylate, poly carboxyl ate, turkey red oil, petroleum sulfonate, alkyldiphenyl-ether sulfonate, and tristyrenephenyl ethoxylate ethylene oxide sulfonate ammonium salt.

9. A kapok-fiber treated with the flame retardant treating agent of claim 1.

10. A kapok-nonwoven fabric treated with the flame retardant treating agent of claim 1.
